(19) United States
(12) Patent Application Publication
(10) Pub. No.: US 2014/0287012 A1
(43) Pub. Date: Sep. 25, 2014

(54) ANTIBACTERIALLY-ACTING MOULDED ARTICLE, METHOD FOR STERILIZING FORMULATIONS, STORAGE VESSEL, AND USE OF THE STORAGE VESSEL

(71) Applicants: Hyeck-Hee Lee, St. Ingbert (DE); Frank Holzer, St. Ingbert (DE); Ute Steinfeld, St. Ingbert (DE); Markus Mahler, Volklingen (DE)

(72) Inventors: Hyeck-Hee Lee, St. Ingbert (DE); Frank Holzer, St. Ingbert (DE); Ute Steinfeld, St. Ingbert (DE); Markus Mahler, Volklingen (DE)

(73) Assignee: F. HOLZER GMBH, St. Ingbert (DE)

(21) Appl. No.: 14/118,503

(22) PCT Filed: May 11, 2012
(86) PCT No.: PCT/EP2012/058803

§ 371 Date: Apr. 17, 2014

(30) Foreign Application Priority Data
May 18, 2011 (DE) 10 2011 106 303.3

(51) Int. Cl. A01N 25/34; A01N 59/20; A01N 59/16

(52) U.S. Cl. CPC A01N 25/34; A01N 59/16; A01N 59/20
USPC 424/409; 206/525; 424/618; 424/630; 424/641

(57) ABSTRACT

The present invention relates to an antibacterially-acting moulded article which is formed from a moulding compound which comprises at least one sort of a particular antibacterial material. The invention is distinguished by the moulded article having an essentially cylindrical, cuboid, spherical or ellipsoid basic body, the basic body having special dimensions which depend upon the average particle diameter of the particular antibacterial material which is used.

The present invention relates to an antibacterially-acting moulded article which is formed from a moulding compound which comprises at least one sort of a particular antibacterial material. The invention is distinguished by the moulded article having an essentially cylindrical, cuboid, spherical or ellipsoid basic body, the basic body having special dimensions which depend upon the average particle diameter of the particular antibacterial material which is used.

An antibacterial glass composition is known from EP 1 496 086 A1, which comprises an antibacterial glass and an inorganic filler which is dispersed in the antibacterial glass composition. This glass composition can be present for example as pellets or as a paste, likewise it is possible to provide the composition in the form of a film, a moulded article or a coating composition. For example, textiles or sheets can be produced herefrom.

However, it is problematic with such moulded articles that the antibacterial effect requires a relatively high content of the antibacterial glass since the antibacterial effect can be attributed to the fact that the antibacterial glass particles must be disposed on the surface of the composition in order to develop their antibacterial effect by contact with the respective bacteria.

Starting from this problem, it is the object of the present invention to indicate an antibacterially-acting moulded article which has an increased antibacterial effect due to the choice of its shape in the case of the same loading with an antibacterially-acting material.

This object is achieved by the moulded article having the features of patent claim 1. Patent claim 13 indicates a method for sterilisation of formulations by means of the moulded article according to the invention. Patent claim 14 describes a storage vessel which comprises a moulded article according to the invention. Finally, purposes of use of the storage vessel are described by patent claim 15. The respective dependent patent claims thereby represent advantageous developments.

According to the invention, an antibacterially-acting moulded article is hence indicated, which moulded article comprises a moulding compound or is formed from this and comprises at least one sort of a particular antibacterial material with an average particle diameter which is present dispersed in at least one synthetic resin, the basis of the moulded article being
a) an essentially cylindrical or cuboid basic body, the maximum diameter of the base of which is at most 100 times the average particle diameter of the particular antibacterial material,
b) an essentially ellipsoid or spherical basic body, the maximum diameter of which is at most 100 times the average particle diameter of the particular antibacterial material, or
c) a conical basic body, the maximum diameter of the base of which is at most 100 times the average particle diameter of the particular antibacterial material.

The principle which underlies the present invention is hence that the maximum diameter of the basic body whether it is the maximum diameter of the base of a cylindrical, cuboid or conical basic body or the maximum diameter of an ellipsoid or spherical basic body—is determined in relation to the average particle diameter of the particular antibacterial material.

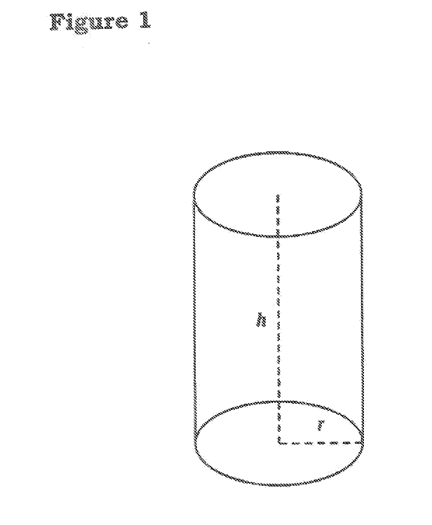

A cylindrical basic body, given by way of example, is thereby represented in FIG. 1. FIG. 1 shows a cylinder with a circular base which has a radius r. The height or length of the cylinder is thereby dimensioned with h. The diameter of the base of the cylinder (i.e. of the circle) is therefore 2r. It is thereby essential to the invention now that the diameter of the base, i.e. 2r, is dimensioned such that at most 100 times the average particle diameter of the particular antibacterial material is given.

This cylinder with the circular base represents however only one possible embodiment of a cylindrical basic body. Likewise, the possibility can be given that the base of the cylindrical basic body is elliptical, n-angular, with 3≦n≦10, or is irregular. There are included herein for example also star-shaped bases.

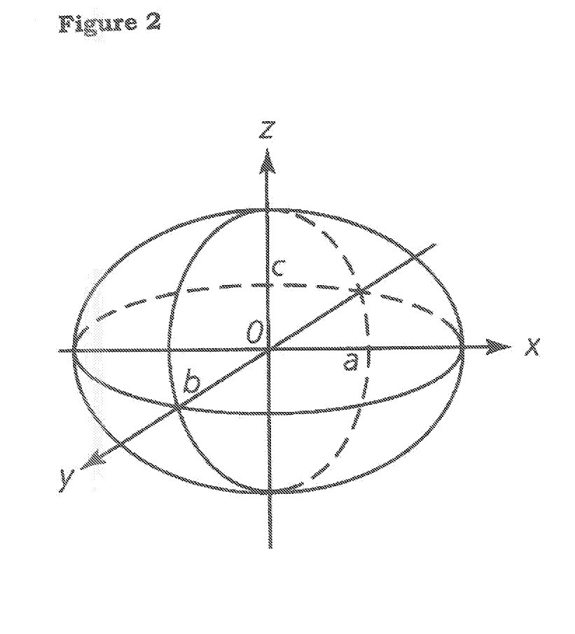

A further basic shape, given by way of example, of the basic body underlying the moulded article is represented in FIG. 2. FIG. 2 shows an ellipsoid, the maximum diameter of which is situated on the x-axis. The maximum diameter of the ellipsoid is hereby 2a. Even for such basic bodies, the principle of the present invention provides that the maximum diameter of such a body is at most 100 times the average particle diameter of the particular antibacterial material. A special embodiment of an ellipsoid basic body is for example a spherical basic body which has merely a single diameter.

Likewise, the principle of the present invention is applicable to conical basic bodies. The base of the cone hereby also fulfils the conditions mentioned in claim 1. The base of the cone can thereby be formed to be circular, ellipsoid but also star-shaped or irregular. The cone can be straight or skewed. Likewise, it is possible that the basic body is configured as a truncated cone.

The principle of the present invention is hence based on the fact that a specific diameter of a basic body has a smaller dimension than 100 times the average particle diameter of the particular antibacterial material which is embedded in the moulding compound of which the basic body consists. This has the effect that merely a small part of the particular antibacterial material is surrounded completely by the moulding compound and a relatively large proportion of this material is disposed in the moulded article such that at least a part of the surface of the particular antibacterial material protrudes from the moulded article, i.e. is disposed on the surface of the moulded article. These particles made of antibacterial material are hence not surrounded completely by the moulding compound which forms the antibacterially-acting moulded article so that, relative to the total proportion of the particular antibacterial material, a relatively large proportion is disposed on the surface of the moulded article and hence can develop an antibacterial effect. A result of this relatively high proportion of the antibacterial material disposed on the surface of the basic body, the moulded article, compared with other moulding compounds in which a higher proportion of the antibacterial material is surrounded completely by the moulding compound, can develop a relatively high antibacterial effect.

As described above, the moulded article is essentially cylindrical or cuboid, essentially ellipsoid or spherical or conical. The feature should hereby be understood essentially such that certain deviations from the ideal geometric principle are permissible. For example, certain “indentations” or “bulges” can be present on the surface of the respective basic body, or certain rounded portions on the edges of the cylinder, which is represented for example in FIG. 1, can be tolerated.

Likewise, the expression “basic body” expresses that it need not hereby be a rigid or geometrically fixed basic body which meets the ideal geometric underlying principles, such as for example a cylinder, cuboid, sphere, ellipsoid or cone, which is hereby of concern.

In FIG. 1, for example, an ideal cylinder is represented, which extends along a straight axis denoted with h. The term basic body according to the present invention likewise comprises embodiments, in which the longitudinal axis of such a cylinder is not straight but for example curved or bent. Of course, this applies likewise to other cylinder shapes, such as e.g. the cuboid as special form of the cylinder or for ellipsoid embodiments.

If the basic body is present as cylinder or as cuboid, at best a comparison with a wire-shaped basic body can be made. In the case where the cylinder or cuboid has a linear course, a straight wire is present which can however likewise be present in a bent shape.

A preferred embodiment of the present invention provides that, starting with a cylindrical or cuboid basic body, the latter is coiled to form a spiral or is present in the shape of a randomly orientated ball. This embodiment has the effect that a more compact configuration of the moulded article according to the invention is present so that the antibacterial effect can be concentrated on the smallest spatial volumes.

A particularly preferred embodiment provides that the maximum diameter of the base of the cylindrical or cuboid basic body or the maximum diameter of the ellipsoid or spherical basic body is from 0.5 to 80 times, preferably from 1 to 60 times, particularly preferred from 2 to 30 times, the average particle diameter of the particular antibacterial material.

For the respective basic bodies, the following preferred absolute dimensionings are produced:

The length or height of the cylindrical or cuboid moulded article is preferably from 1 mm to 100 cm, further preferred from 5 mm to 80 cm, particularly preferred from 10 mm to 60 cm andor the maximum diameter of the base of the cylindrical or cuboid basic body or the maximum diameter of the ellipsoid or spherical basic body is less than 5 mm, preferably from 0.01 to 0.9 mm.

In a further preferred embodiment, the at least one sort of particular antibacterial material is a particular antibacterial glass, in particular a particular antibacterial glass selected from the group consisting of element glass, oxide glass, silicate glass, silica glass, alkalisilicate glass, soda-lime glass, lead (alkali) glass, barium glass, borosilicate glass, phosphate glass, borate glass, fluoride glass, chloride glass, sulphide glass, carbonate glass, nitrate glass, sulphate glass, water-soluble glass, crystallised glass and also mixtures hereof

Preferably, the surface of the particles of the at least one sort of particular antibacterial material is coated at least partially or entirely with an antibacterially-acting metal, in particular a metal selected from the group consisting of silver, copper, zinc andor mixtures or combinations hereof, andor comprises ions andor colloids of the previously mentioned metals.

Furthermore, it is advantageous if the average particle diameter of the particles of the particular antibacterial material is 0.05 to 50 μm, preferably 0.1 to 25 μm, particularly preferred 2 to 10 μm.

Preferred contents of the metal andor of the metal ions are thereby, relative to the total mass of particular antibacterial material, of 0.01% by weight or more, preferably from 0.01 to 50% by weight.

In addition, the moulding compound can comprise at least one particular inorganic filler which is selected preferably from the group consisting of barium andor barium salts, silver or silver salts, silica, zeolites, kaolin, talcum, zinc oxide and also mixtures hereof

These particular inorganic fillers which are possibly contained in addition thereby have preferably average particle diameters of 0.1 to 10 μm.

Preferred synthetic resins which can form the basis of the moulded article according to the invention are thereby selected from the group consisting of
a) thermoplastics, in particular polyvinyl chloride, polyethylene, polypropylene, acrylonitrile-butadiene-styrene resins (ABS resins), acrylonitrile-styrene-resins (AS resins), polystyrene, polyesters, polyvinylidene chloride, polyamides, polybutylene terephthalate (PBT), saturated polyesters, polyacetals, polyvinyl alcohols, polycarbonates, urethane resins, poly(meth)acrylates, polyacrylic acid, (partially) fluorinated resins, ethylene vinyl alcohols (EVA) andor combinations hereof,
b) heat-curing resins, in particular silicone resins, modified silicone resins, unsaturated polyesters, vinyl ester resins, phenol resins, melamine resins, urea resins, epoxy resins andor combinations hereof,
c) rubber materials, in particular based on natural or synthetic rubber andor combinations hereof, and also
d) mixtures of the previously mentioned resins.

Preferred contents of the at least one sort of particular antibacterial material are thereby, relative to the moulding compound, at least 0.01% by weight, preferably 0.01% by weight to 50% by weight and particularly preferred 0.1% by weight to 15% by weight.

Furthermore, it is possible, in the case where particular inorganic fillers are incorporated in addition, that these can comprise a content of 3 to 50% by weight, relative to the at least one sort of particular antibacterial material.

According to the invention, a method is likewise indicated for sterilisation of formulations selected from the group consisting of liquids, solutions, dispersions, suspensions, gels, organogels, microemulsion gels, pastes andor creams, in particular for pharmaceutical, cosmetic andor foodstuff applications, in which at least one moulded article according to the invention is brought in contact with the previously mentioned formulations.

In addition, the present invention relates to a storage vessel, in which at least one moulded article according to the invention is disposed in the interior of the storage vessel. The storage vessel is thereby suitable in particular for sterile storage of liquids, solutions, dispersions, suspensions, gels, organogels, microemulsion gels, pastes andor creams, in particular for pharmaceutical, cosmetic andor foodstuff applications, or can be used for this purpose. The previously mentioned components, i.e. liquids, solutions, dispersions, suspensions, gels, organogels, microemulsion gels, pastes andor creams, can be sterilised for example before introduction into the storage vessel and storage of these components by means of a method known from the state of the art. The moulded article then serves for maintaining sterility during storage.

However it is likewise possible and conceivable that the previously mentioned components are introduced unsterilised into the storage vessel, sterilisation being effected upon first contact with the antibacterially-acting moulded article according to the invention. In the case of both variants, maintaining sterility is ensured during the entire period of storage.

The present invention is described in more detail with reference to the subsequent Figures without restricting the invention to the special embodiments represented there.

FIG. 1 shows a circular cylinder as possible basic shape of the moulded article according to the invention.

FIG. 2 shows an ellipsoid as possible basic shape of the moulded article according to the invention.

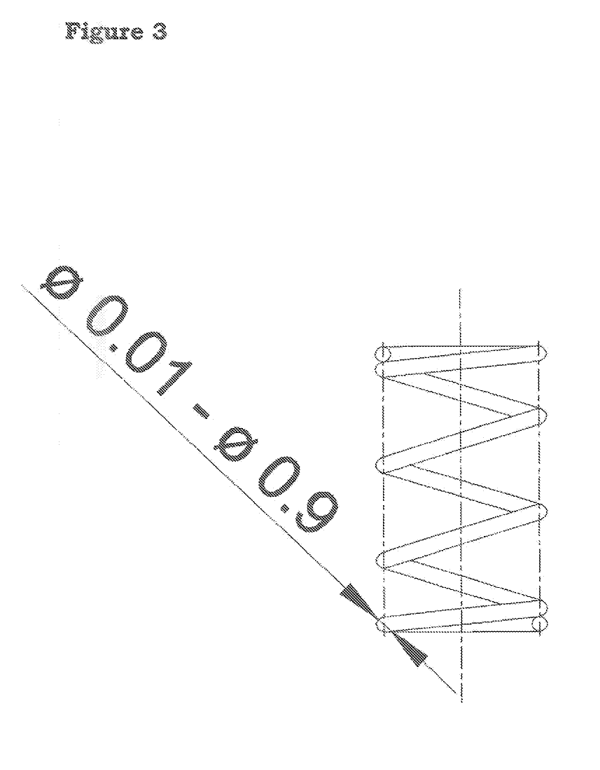

FIG. 3 shows a further variant of an embodiment of the moulded article according to the invention. This thereby has a circular cylindrical basic body which is present coiled to form a spiral with approx. 4, 5 coils. The preferred diameter of the base of the basic body, i.e. the circular base of the cylinder, is thereby preferably from 0.01 to 0.9 mm.

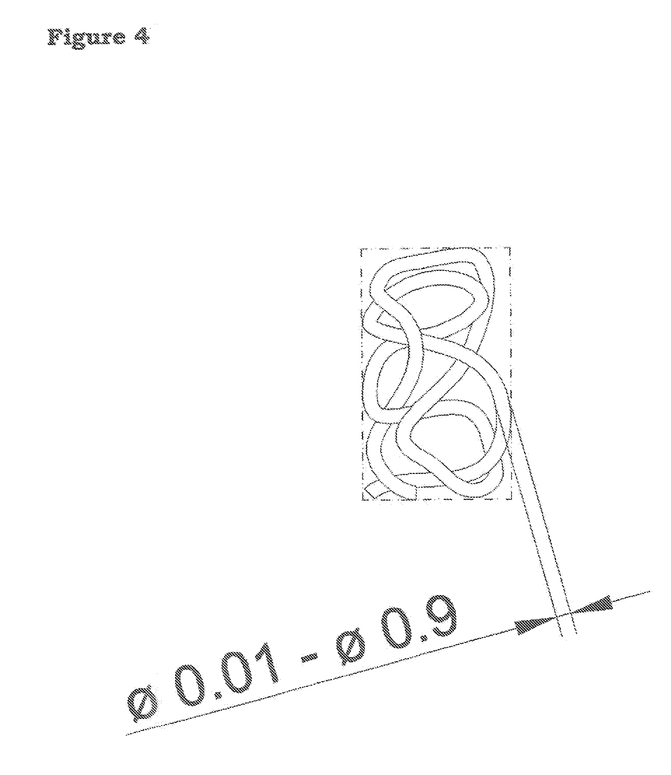

FIG. 4 relates to a further preferred geometric embodiment of a basic body according to the invention which, in this case, is present as randomly orientated ball. Underlying this basic body is also a circular cylindrical basic body which can be manufactured by corresponding coiling to form the randomly orientated ball. The diameter of the circular base of the cylinder is also here preferably from 0.01 to 0.9 mm.

1. An antibacterially-acting moulded article, comprising or formed from a moulding compound, comprising at least one antibacterial material with an average particle diameter which is present dispersed in at least one synthetic resin,
wherein the basis of the moulded article is
a) an essentially cylindrical or cuboid basic body, the maximum diameter of the base of which is at most 100 times the average particle diameter of the antibacterial material,
b) an essentially ellipsoid or spherical basic body, the maximum diameter of which is at most 100 times the average particle diameter of the antibacterial material, or
c) a conical basic body, the maximum diameter of the base of which is at most 100 times the average particle diameter of the antibacterial material.

2. The moulded article according to claim 1, wherein the basic body is an essentially cylindrical or cuboid basic body which is coiled to form a spiral or is present in the form of a randomly orientated ball.

3. The moulded article according to claim 1, wherein the maximum diameter of the base of the cylindrical or cuboid basic body or the maximum diameter of the ellipsoid or spherical basic body is from 0.5 to 80 times, the average particle diameter of the antibacterial material.

4. The moulded article according to claim 1, wherein
a) the length of the cylindrical or cuboid moulded article is from 1 mm to 100 cm, and/or
b) the maximum diameter of the base of the cylindrical or cuboid basic body or the maximum diameter of the ellipsoid or spherical basic body is less than 5 mm,

5. The moulded article according to claim 1, wherein the base of the cylindrical basic body is circular, elliptical, n-angular, with 3≦n≦10, or is irregular.

6. The moulded article according to claim 1, wherein the at least one antibacterial material is an antibacterial glass, selected from the group consisting of element glass, oxide glass, silicate glass, silica glass, alkalisilicate glass, soda-lime glass, lead or alkali glass, barium glass, borosilicate glass, phosphate glass, borate glass, fluoride glass, chloride glass, sulphide glass, carbonate glass, nitrate glass, sulphate glass, water-soluble glass, crystallised glass and also mixtures thereof.

7. The moulded article according to claim 1, wherein the surface of the particles of the at least one antibacterial material has an at least partial or entire coating of an antibacterially-acting metal, metal ion, and/or colloid of the metal.

8. The moulded article according to claim 7, wherein
a) the average particle diameter of the antibacterial material is 0.05 to 50 μ, and/or
b) the content of the metal andor of the metal ions, relative to the total mass of the antibacterial material, is of 0.01% by weight or more,

9. The moulded article according to claim 1, wherein the moulding compound comprises in addition at least one inorganic filler selected from the group consisting of barium andor barium salts, silver andor silver salts, silica, zeolites, kaolin, talcum, zinc oxide and also mixtures thereof.

10. The moulded article according to claim 9, wherein the at least one filler has an average particle diameter of 0.1 to 10 μm.

11. The moulded article according to claim 1, wherein the at least one synthetic resin is selected from the group consisting of
a) thermoplastics,
b) heat-curing resins,
c) rubber materials, and
d) mixtures of a, b, and c.

12. The moulded article according to claim 1, wherein the content
a) of the at least one antibacterial material, relative to the moulding compound, is at least 0.01% by weight, and/or
b) if necessary of the at least one particular inorganic filler, relative to the at least one antibacterial material, is 3 to 50% by weight.

13. A method for sterilisation of formulations selected from the group consisting of liquids, solutions, dispersions, suspensions, gels, organogels, microemulsion gels, pastes, and creams, in which at least one moulded article according to claim 1 is brought in contact with said formulations.

14-15. (canceled)

16. A storage vessel comprising at least one moulded article according to claim 1 disposed in the interior of said storage vessel.

17. A method of sterilization andor storage of liquids, solutions, dispersions, suspensions, gels, organogels, microemulsion gels, pastes andor creams, pharmaceutical formulations, cosmetic or foodstuff applications comprising storing said liquids, solutions, dispersions, suspensions, gels, organogels, microemulsion gels, pastes andor creams, pharmaceutical formulations, cosmetic or foodstuff applications in a storage vessel according to claim 16.

18. The moulded article according to claim 3, wherein the maximum diameter of the base of the cylindrical or cuboid basic body or the maximum diameter of the ellipsoid or spherical basic body is from 1 to 60 times the average particle diameter of the antibacterial material.

19. The moulded article according to claim 18, wherein the maximum diameter of the base of the cylindrical or cuboid basic body or the maximum diameter of the ellipsoid or spherical basic body is from 2 to 30 times the average particle diameter of the antibacterial material.

20. The moulded article according to claim 4, wherein
a) the length of the cylindrical or cuboid moulded article is from 5 mm to 80 cm, andor
b) the maximum diameter of the base of the cylindrical or cuboid basic body or the maximum diameter of the ellipsoid or spherical basic body is from 0.01 to 0.9 mm.

21. The moulded article according to claim 7, wherein the metal is selected from the group consisting of silver, copper, zinc andor mixtures or combinations thereof.

22. The moulded article according to claim 11, wherein:
a) the thermoplastics are selected from polyvinyl chloride, polyethylene, polypropylene, acrylonitrile-butadiene-styrene resins (ABS resins), acrylonitrile-styrene-resins (AS resins), polystyrene, polyesters, polyvinylidene chloride, polyamides, polybutylene terephthalate (PBT), saturated polyesters, polyacetals, polyvinyl alcohols, polycarbonates, urethane resins, poly(meth)acrylates, polyacrylic acid, (partially) fluorinated resins, ethylene vinyl alcohols (EVA) and combinations thereof,
b) the heat-curing resins are selected from silicone resins, modified silicone resins, unsaturated polyesters, vinyl ester resins, phenol resins, melamine resins, urea resins, epoxy resins and combinations thereof,
c) rubber materials are selected from natural and synthetic rubbers and combinations thereof; or
d) a combination of a), b), c), and d).
